(19) United States
(12) Patent Application Publication
(10) Pub. No.: US 2025/0116174 A1
(43) Pub. Date: Apr. 10, 2025

(54) STABILITY EVALUATION APPROACH FOR PRODUCTION METERING OPTIMIZATION

(71) Applicant: Schlumberger Technology Corporation, Sugar Land, TX (US)

(72) Inventors: Denis Syresin, Sugar Land, TX (US); Jean-Philippe Hussenet, Sugar Land, TX (US); Roman Vladimirovich Korkin, Katy, TX (US); Yermek Kaipov, Dhahran (SA)

(21) Appl. No.: 18/906,858

(22) Filed: Oct. 4, 2024

Related U.S. Application Data
(60) Provisional application No. 63/588,198, filed on Oct. 5, 2023.

(51) Int. Cl. E21B 43/12; E21B 47/10; G01F 15/00

(52) U.S. Cl. CPC E21B 43/12; E21B 47/10; G01F 15/003

(57) ABSTRACT

Embodiments presented provide for an optimization approach for production metering. The optimization approach uses a stability evaluation with data sets to provide for accurate decision making by a user.

### CROSS-REFERENCE TO RELATED APPLICATIONS

This application claims priority to and the benefit of U.S. Provisional Patent Application Ser. No. 63/588, 198, entitled “STABILITY EVALUATION APPROACH FOR PRODUCTION METERING OPTIMIZATION,” filed Oct. 5, 2023, which is hereby incorporated by reference in its entirety for all purposes.

### FIELD OF THE DISCLOSURE

Aspects of the disclosure relate to evaluation of data used in the hydrocarbon recovery industry. More specifically, aspects of the disclosure relate to stability evaluations approaches for production metering optimization.

### BACKGROUND

One of the major trends in the hydrocarbon recovery industry is the growing demand for the continuous measurements from systems as well as metering of systems. For these systems, there is a high level of automated monitoring that is required as well as the ability for individuals to control process optimization. To achieve such production metering services requires the accurate evaluation of the flowrates using various measurement units. To achieve this, several independent sensors are used. Each of these independent sensors must be continually monitored. Field experience shows that such physical measurements experience dynamical and non-stationary behavior or anomalies, which complicates analysis.

In instances of multiphase flowmeters, the reasons for non-stationary measurements are due to several factors including complexity of flow-regimes, changes in reservoir and pressure behavior, gas-liquid slugging, work of well equipment and electric submersible pumps, hereinafter “ESPs”, deposition of scales, as well as other causes. Discarding these dynamics may prevent detecting changes in well production profiles during well operation. Monitoring a large population of wells with these dynamics is critical. To mitigate changes in these dynamics, there is a need for intervention to optimize production. For ESP successful operation, the pressure and the flowrate should be within the operating parameters. Working in a well with a low flow rate can cause overheating and premature failure. Exceeding limits for a well is not recommended, as pipelines and processing equipment are matched to the well for throughput capacity. Rates that are too low are economically inefficient and can cause the formation of scales, hydrates, and ice deposition in the pipelines.

One effective way to optimize complex systems, including production metering systems, is to quantify the stability of the sensors' measurements and average data within mathematically, justified, representative, time-intervals. To date, such operations are not performed in conventional well systems. Instead, wells are merely measured at different rates and different conditions, when decisions are made based on overall engineers' experience, causing the drawbacks discussed above to occur with increasing frequency.

Statistical process control is used for solving different problems and uses a fairly wide class of methods. When solving problems by statistical process control, the methods used commonly generate diagrams and graphs which may be used in detailed analysis. Currently, conventional systems do not provide detailed methods that produce diagrams or graphs that may be used in analysis. Further deficiencies exist in conventional methods of operation where no index of data is created that may be used in studying stability. Because of this, any data pertaining to conventional systems may be useful only for rough, qualitative analysis, and cannot be used quantitative results. Accordingly, the use of conventional systems cannot be used for accurate decision making and analysis.

There is a need to provide an apparatus and methods that are easier to operate than conventional apparatus and methods.

There is a further need to provide apparatus and methods that do not have the drawbacks discussed above, namely the inability of conventional system to facilitate accurate decision making.

There is a need to provide better evaluation approaches to production metering currently used and to reduce economic costs associated with operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for production metering optimization is disclosed. The method may include obtaining data related to metering operations. The method may further include determining when the data of the metering operations is quasi-periodic. The method may further include when the data of the metering operation is quasi-periodic, performing a filtering of periodical components of the data, creating remaining data. The method may further include when the data of the metering operation is not quasi-periodic, making the data related to metering operations the remaining data. The method may further include calculating qualitative index of stability values for the remaining data. The method may further include analyzing the calculated index of stability values for trends. The method may further include conducting an optimization of the metering operations based upon instabilities identified.

In another example embodiment, an article of manufacture is disclosed. The article of manufacture is configured with a non-volatile memory, wherein a set of instructions configured to be read by a computer, the set of instructions comprising a method for production metering optimization. The method in the non-volatile memory may comprise obtaining data related to metering operations. The method in the non-volatile memory may further comprise determining when the data of the metering operations is quasi-periodic. The method in the non-volatile memory may further comprise when the data of the metering operation is quasi-periodic, performing a filtering of periodical components of the data, creating remaining data. The method in the non-volatile memory may further comprise when the data of the metering operation is not quasi-periodic, making the data related to metering operations the remaining data. The method in the non-volatile memory may further comprise calculating qualitative index of stability values for the remaining data. The method in the non-volatile memory may further comprise analyzing the calculated index of stability values for trends. The method in the non-volatile memory may further comprise conducting an optimization of the metering operations based upon the trends identified.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a graph of quantitative index of stability (QIS) index (q) computation for three datasets with growing amplitude of trend.

FIG. 2 is an example of the spectrum (left) and time-series (right) data, visually confirmed as periodical.

FIG. 3 is an example of the spectrum (left) and time-series (right) data, visually confirmed as non-periodical.

FIG. 4 is an example of STL decomposition: top—original time series, second—computed trend, third—computed periodical component, fourth—residual of STL decomposition.

FIG. 5 is a method of stability evaluation for production metering optimization.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide for a method for stability evaluation of multi-dimensional time-series sensors' data typical for production metering optimization. Such methods may be used in hydrocarbon recovery operations or other settings where metering quality may be inaccurate due to signal instability over time. Aspects of the current disclosure present an approach to characterize the stability of physical measurements using Quantitative Index of Stability methodology. In aspects of the disclosure, this methodology consists of using two mathematical approaches as follows:
1. A mathematical approach to characterize finite-length multi-dimensional Time Series using the index of stability (QIS). This approach is general and can be applied for diverse types of measurements. A single scalable metric characterizing the “Stability” of the measured data within predefined time window is produced.
2. A mathematical approach on periodicity and trend data analysis for multi-dimensional Time Series. This mathematical approach includes computation of a periodicity index (QPI), which characterizes the degree of periodicity existing in data.

One advantage of embodiments of the disclosure is the ability of the methodologies to quantify the stability of actual measurements and extract additional characteristics such as QIS and QPI indices which are of high importance for data analytics application. In conventional methodologies that average signals/numbers, the ability to discern high importance data is not possible.

Another advantage of the disclosure lies in the ability on being able to conduct measurement automation as well as optimization of systems based on signal behavior. Because aspects of the disclosure provide for an automated decision-making system, aspect of the disclosure presented herein improves equipment leveraging and accuracy. In one example, highly unstable data intervals are removed, and the methodology proposes an optimal measurement duration, informing a user about various signal anomalies and instabilities. Trends may be identified through aspects of the disclosure, such as seasonality of data, presence of outliers, rises or falls in data, low signal to noise ratio as non-limiting examples.

### Quantitative Index of Stability

In one embodiment, aspects of the method estimate a stability index (QIS) of the single-column Time Series. The following formulation of the QIS for Time-Series data (X) is used:

$$QIS ( X ) = f ( SNR ( X ) ) \cdot τ ( X ) , \qquad ( 1 )$$

where QIS index is a product of function (ƒ) of signal-to-noise ratio statistics (SNR) for the X=(x₁, . . . , xₙ)−Time Series (TS) and function τ(X) which is a stability index based on algebraic analysis of long and short-time trends and changes in Time Series data.

The QIS metric can be applied towards to any finite-length time series data. In Equation (1) excellent sensitivity is shown towards various types of instabilities including signal to noise ratio value, trends, mean-value changes, dispersion changes, periodicity, and outliers.

To apply the formula (1) for multi-dimensional Time Series data equation 2, recited below, is an averaging algorithm, to compute single metric for the whole measurement:

$${QIS}_{MD} = \frac{{\sum }_{j = 1}^{M} {w}_{j} \cdot QIS ( {X}^{( j )} )}{{\sum }_{j = 1}^{M} {w}_{j}} . \qquad ( 2 )$$

Equation 2 is used to compute multi-dimensional index of stability QIS_{MD} by applying weighted averaging for M single value QIS(X^{(j)}) indices, computed with Equation (1). The value M is defined as the total number of various columns (sensors' signals), for which single-value QIS indices were computed. The magnitudes of weights wⱼ can be defined based on the problem to be solved.

As can be seen, Equations 1 and 2 can be applied to the measurements of different nature and time-series of different lengths. The QIS_{MD} value is sensitive to the majority of instabilities and converges to zero in the case of highly non-stationary measurements.

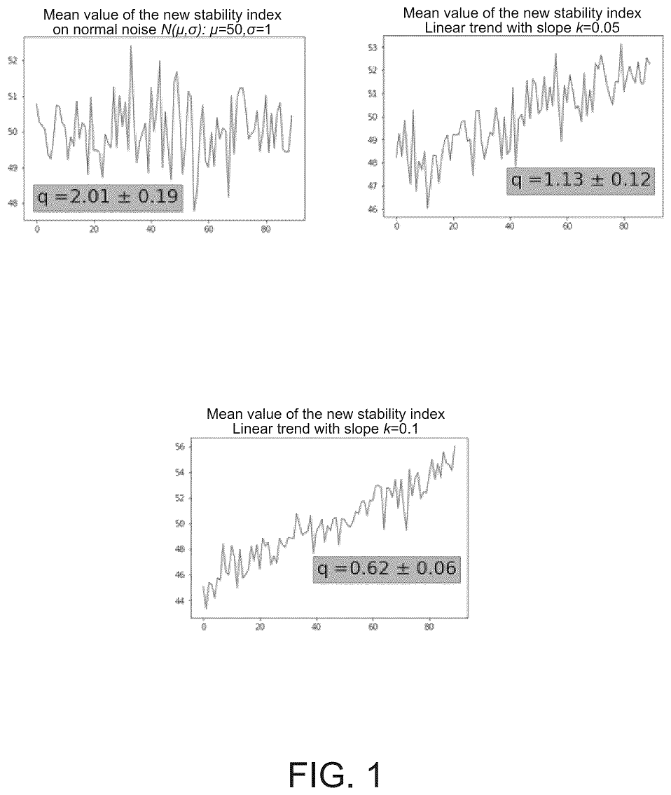

Referring to FIG. 1, the application of Equation (1) for three, synthetic, time-series with trend of various amplitudes is shown. In FIG. 1, the QIS value q is decreasing when the trend amplitude is growing.

### Quantitative Periodicity Index

In aspects of the disclosure, the time series may be determined as quasi-periodical and the periodic component can be characterized by a periodicity index which is then subjected to a filtering prior to the value QIS being computed. The Periodicity Index (QPI) is defined as a function of the signal's spectral peak amplitude Ampₚₖ, width of the peak Wₚₖ, and average amplitude level of spectral amplitude outside the peak [symbol] .

$$QPI = F ( {Amp}_{p k} , {W}_{p k} , ) . \qquad ( 4 )$$

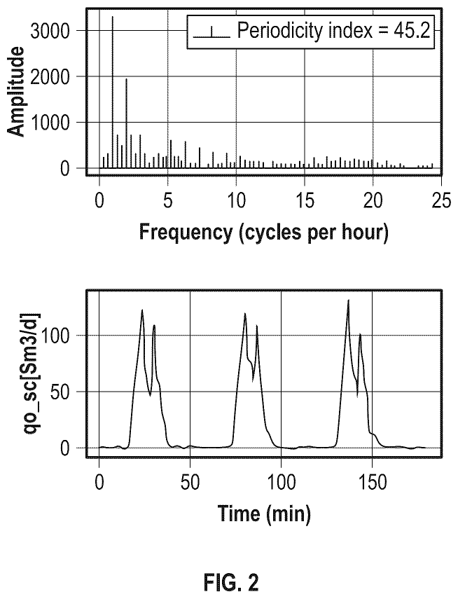

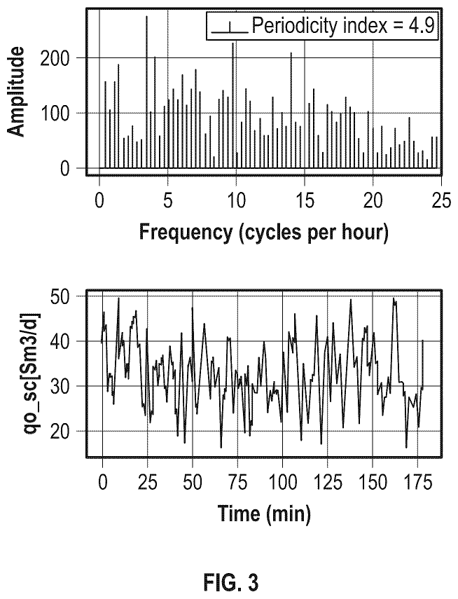

Referring to FIGS. 2 and 3, two examples of QPI computations are shown. When the QPI index is computed, the algorithm compares the QPI index value with a predefined threshold. In instances, labels are automatically attached to the time series, wherein the label indicates non-periodical or periodical data. To extend this approach for multi-dimensional signals analysis, the average QPI index for all columns is computed. If the averaged QPI index also exceeds the threshold, the whole measurement is considered as quasi-periodical with averaged QPI index [symbol] .

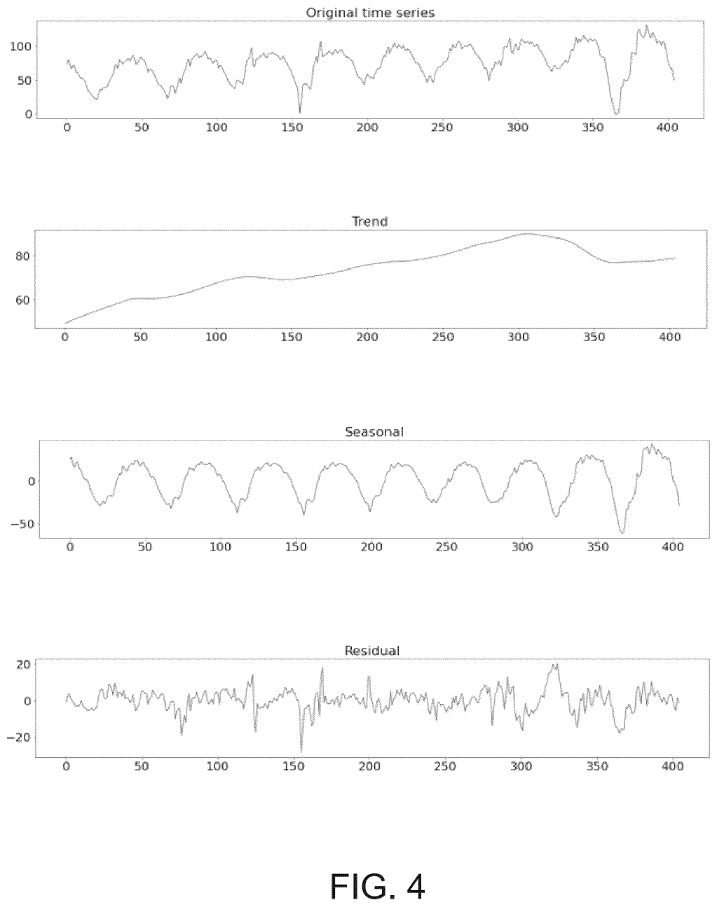

After the central frequency and [symbol] index are defined, any periodical components can be filtered out and the QIS index computed on resulted Time-Series. The one approach which can be applied to filter out periodicity from the data lies in application of standard time or frequency domain filters, the other lies in application of Seasonal-Trend by Loess decomposition. An example of this is illustrated in FIG. 4. Both approaches can use computed central frequency value as an input. Resulted signal can be analyzed further, for example, to evaluate the trend parameters.

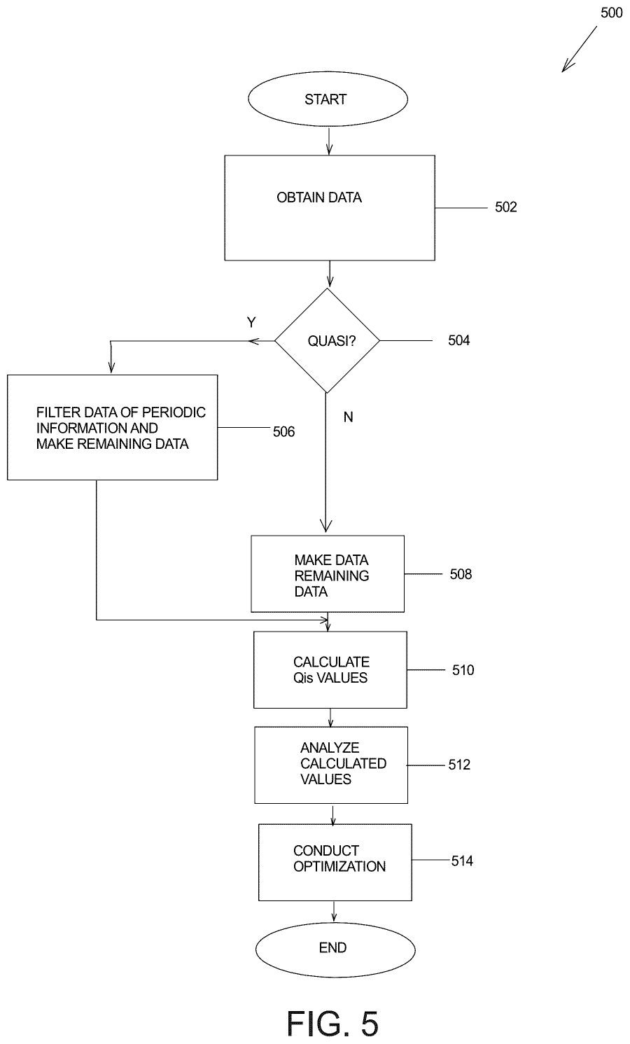

Referring to FIG. 5, a method 500 for production metering optimization is disclosed. The method may comprise, at 502, obtaining time-series data related to metering operations. The method may also comprise, at 504, determining when the data of the metering operations is quasi-periodic. The method may also comprise, at 506, when the data of the metering operation is quasi-periodic, performing a filtering of periodical components of the data, creating remaining data. The method may also comprise, at 508, when the data of the metering operation is not quasi-periodic, making the data related to metering operations the remaining data. The method may also comprise, at 510, calculating qualitative index of stability values for the remaining data. The method may also comprise, at 512 analyzing the calculated index of stability values for trends. The method may also comprise, at 514 conducting an optimization of the metering operations based upon the trends identified.

Aspects of methods described may be included onto a non-volatile memory system. For definitional purposes, a non-volatile memory system may be a memory system that does not wipe clean after termination of electrical power to the system. Examples of non-volatile memory systems may be compact disks, solid-state drives, and universal serial bus devices. These memory systems may be used to store program executable method steps for a computer, server, or computing arrangement. Thus, the method may be made into a series of steps that may be performed through computer operation. The series of steps may, in some embodiments, require user input. In other embodiments, the method may take data from various field locations and then process the results. The results may be displayed on a monitor, as needed. In embodiments, the method may be used to control numerous field locations that are under production. In such embodiments, a cloud computing device or arrangement may be used to perform the required analysis.

As will be understood, optimization may include operating a component within one of the monitored systems to adjust measured values. Such alteration of the monitored systems may include, for example, enabling an actuator to change a valve setting in the monitored system. To achieve such a result, the method steps described in FIG. 5 may interface with a control system for the metering operation and provide inputs for actuator control. In some instances, a notification to a user may be provided, showing an anomalous reading accompanied by a warning. As will be understood, optimization may include detection of the stable and unstable measurement intervals and definition of the measurement duration time necessary for accurate data averaging. To achieve a result the method step described in FIG. 5 may interface with a control system for the metering operation and provide inputs for actuator control. In some instances, a notification to a user may be provided, showing an the most stable and unstable time intervals and estimation time for measurement to be completed based on the stability.

In some configurations, artificial intelligence may be coupled with the stability evaluation approach conducted herein. As the stability evaluation approach allows for exclusion of data that would affect results, the data may be considered of a quality high enough to allow for artificial intelligence training to allow for further predictive actions to be undertaken. To enable such artificial intelligence training, additional steps of recording data pertaining to the production metering optimization may be performed as part of the method described in FIG. 5. Such recording may occur on a non-volatile memory device, such as a universal serial bus, a compact disk, computer hard disc, computer solid state memory device or web-based storage.

Example embodiments of the disclosure are now disclosed. The example embodiments should not be considered limiting. In one example embodiment, a method for production metering optimization is disclosed. The method may include obtaining data related to metering operations. The method may further include determining when the data of the metering operations is quasi-periodic. The method may further include when the data of the metering operation is quasi-periodic, performing a filtering of periodical components of the data, creating remaining data. The method may further include when the data of the metering operation is not quasi-periodic, making the data related to metering operations the remaining data. The method may further include calculating qualitative index of stability values for the remaining data. The method may further include analyzing the calculated index of stability values for trends. The method may further include conducting an optimization of the metering operations based upon instabilities identified.

In another example embodiment, the method may be performed wherein the metering relates to a hydrocarbon recovery operation.

In another example embodiment, the method may be performed wherein the data is multi-dimensional.

In another example embodiment, the method may be performed wherein the stability index is defined by an equation QIS(X)=ƒ(SNR(X))·τ(X), where SNR is a signal-to-noise ratio statistics for a value of X on a time series and a the function τ(X) is a stability index based on algebraic analysis of long and short-time trends and changes in time series data.

In another example embodiment, the method may be performed wherein the stability index is defined by an equation

$${QIS}_{MD} = \frac{{\sum }_{j = 1}^{M} {w}_{j} \cdot QIS ( {X}^{( j )} )}{{\sum }_{j = 1}^{M} {w}_{j}} ,$$

wherein QIS(X) is defined as a ƒ(SNR(X))·τ(X), where SNR is a signal-to-noise ratio statistics for a value of X on a time series and a the function τ(X) is a stability index based on algebraic analysis of long and short-time trends and changes in time series data and M is defined as a total number of columns for which single value QIS indices are computed and wⱼ is defined as a weight.

In another example embodiment, the method may be performed wherein the stability index is defined by an equation

$${QIS}_{MD} = \frac{{\sum }_{j = 1}^{M} {w}_{j} \cdot QIS ( {X}^{( j )} )}{{\sum }_{j = 1}^{M} {w}_{j}} ,$$

wherein QIS(X) is defined as a ƒ(SNR(X))·τ(X), where SNR is a signal-to-noise ratio statistics for a value of X on a time series and a the function τ(X) is a stability index based on algebraic analysis of long and short-time trends and changes in time series data and M is defined as a total number of columns of sensor signals for which single value QIS indices are computed and wⱼ is defined as a weight.

In another example embodiment, the method may be performed wherein the data related to the metering operations involves at least one of a complex flow-regime, a change in reservoir and pressure behavior, and gas-liquid slugging.

In another example embodiment, the method may be performed wherein the conducting the optimization of the metering operations based upon the trends identified is operating at least one mechanical component in the production metering operation.

In another example embodiment, the method may be performed wherein the filtering of the data includes removing one of a rise and fall in data over a threshold value.

In another example embodiment, the method may be performed wherein the filtering of the data includes removing signal to noise ratio below a designated threshold.

In another example embodiment, the method may be performed wherein the data is time dependent data.

In another example embodiment, the method may be performed wherein the data includes signal to noise ratios.

In another example embodiment, the method may further comprise recording at least one of the remaining data, and index of stability values.

In another example embodiment, the method may be performed wherein the obtaining data related to metering operations includes obtaining the data from a remote location.

In another example embodiment, the method may be performed wherein the obtaining the data from the remote location is performed on a wireless network.

In another example embodiment, an article of manufacture is disclosed. The article of manufacture is configured with a non-volatile memory, wherein a set of instructions configured to be read by a computer, the set of instructions comprising a method for production metering optimization. The method in the non-volatile memory may comprise obtaining data related to metering operations. The method in the non-volatile memory may further comprise determining when the data of the metering operations is quasi-periodic. The method in the non-volatile memory may further comprise when the data of the metering operation is quasi-periodic, performing a filtering of periodical components of the data, creating remaining data. The method in the non-volatile memory may further comprise when the data of the metering operation is not quasi-periodic, making the data related to metering operations the remaining data. The method in the non-volatile memory may further comprise calculating qualitative index of stability values for the remaining data. The method in the non-volatile memory may further comprise analyzing the calculated index of stability values for trends. The method in the non-volatile memory may further comprise conducting an optimization of the metering operations based upon the trends identified.

In another example embodiment, the method may be performed by the article of manufacture uses data that is multi-dimensional.

In the following description, description is provided related to measurements obtained during wireline operations generally performed, as described above. As will be understood, various changes and alterations may be accomplished during the attainment of the desired measurements, and as such, methods described should not be considered limiting.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for production metering optimization, comprising:
obtaining data related to metering operations;
determining when the data of the metering operations is quasi-periodic;
when the data of the metering operation is quasi-periodic, performing a filtering of periodical components of the data, creating remaining data;
when the data of the metering operation is not quasi-periodic, making the data related to metering operations the remaining data;
calculating qualitative index of stability values for the remaining data;
analyzing the calculated index of stability values for trends; and
conducting an optimization of the metering operations based upon instabilities identified.

2. The method according to claim 1, wherein the metering relates to a hydrocarbon recovery operation.

3. The method according to claim 1, wherein the data is multi-dimensional.

4. The method according to claim 3, wherein the stability index is defined by an equation QIS(X)=ƒ(SNR(X))·τ(X), where SNR is a signal-to-noise ratio statistics for a value of X on a time series and a the function τ(X) is a stability index based on algebraic analysis of long and short-time trends and changes in time series data.

5. The method according to claim 3, wherein the stability index is defined by an equation
$${QIS}_{MD} = \frac{{\sum }_{j = 1}^{M} {w}_{j} \cdot QIS ( {X}^{( j )} )}{{\sum }_{j = 1}^{M} {w}_{j}} ,$$
wherein QIS(X) is defined as a ƒ(SNR(X))·τ(X), where SNR is a signal-to-noise ratio statistics for a value of X on a time series and a the function τ(X) is a stability index based on algebraic analysis of long and short-time trends and changes in time series data and M is defined as a total number of columns for which single value QIS indices are computed and wⱼ is defined as a weight.

6. The method according to claim 3, wherein the stability index is defined by an equation
$${QIS}_{MD} = \frac{{\sum }_{j = 1}^{M} {w}_{j} \cdot QIS ( {X}^{( j )} )}{{\sum }_{j = 1}^{M} {w}_{j}} ,$$
wherein QIS(X) is defined as a ƒ(SNR(X))·τ(X), where SNR is a signal-to-noise ratio statistics for a value of x on a time series and a the function τ(X) is a stability index based on algebraic analysis of long and short-time trends and changes in time series data and M is defined as a total number of columns of sensor signals for which single value QIS indices are computed and wⱼ is defined as a weight.

7. The method according to claim 1, wherein the data related to the metering operations involves at least one of a complex flow-regime, a change in reservoir and pressure behavior, and gas-liquid slugging.

8. The method according to claim 1, wherein the conducting the optimization of the metering operations based upon the trends identified is operating at least one mechanical component in the production metering operation.

9. The method according to claim 1, wherein the conducting the optimization may include detection of the stable and unstable measurement intervals and definition of the measurement duration time necessary for accurate data averaging.

10. The method according to claim 1, wherein the filtering of the data includes removing one of a rise and fall in data over a threshold value.

11. The method according to claim 1, wherein the filtering of the data includes removing parts of data with a stability index below a designated threshold.

12. The method according to claim 1, wherein the data is time dependent data.

13. The method according to claim 1, wherein the data includes signal to noise ratios.

14. The method according to claim 1, further comprising recording at least one of the remaining data, and index of stability values.

15. The method according to claim 1, wherein the obtaining data related to metering operations includes obtaining the data from a remote location.

16. The method according to claim 14, wherein the obtaining the data from the remote location is performed on a wireless network.

17. An article of manufacture, configured with a non-volatile memory, wherein a set of instructions configured to be read by a computer, the set of instructions comprising a method for production metering optimization, comprising:
obtaining data related to metering operations;
determining when the data of the metering operations is quasi-periodic;
when the data of the metering operation is quasi-periodic, performing a filtering of periodical components of the data, creating remaining data;
when the data of the metering operation is not quasi-periodic, making the data related to metering operations the remaining data;
calculating qualitative index of stability values for the remaining data;
analyzing the calculated index of stability values for trends; and
conducting an optimization of the metering operations based upon the trends identified.

18. The article of manufacture of claim 16, wherein the data used in the method is multi-dimensional.
